(19) United States
(12) Patent Application Publication
(10) Pub. No.: US 2016/0016346 A1
(43) Pub. Date: Jan. 21, 2016

(54) METHOD FOR CONTROLLING A MELT-PROCESSING INSTALLATION

(71) Applicants: Christian Lebert, Hausen (DE); Harald Pohl, Horstel (DE)

(72) Inventors: Christian Lebert, Hausen (DE); Harald Pohl, Horstel (DE)

(21) Appl. No.: 14/866,513

(22) Filed: Sep. 25, 2015

Related U.S. Application Data
(63) Continuation of application No. PCT/EP2014/000806, filed on Mar. 25, 2014.

(30) Foreign Application Priority Data
Mar. 25, 2013 (DE) 102013005199.1
Mar. 25, 2014 (EP) PCT/EP2014/000806

(51) Int. Cl. B29C 47/92; B29C 47/00

(52) U.S. Cl. CPC B29C 47/92; B29C 47/0026; B29C 2947/92152; B29C 2947/92447; B29C 2947/926; B29C 2947/92876

(57) ABSTRACT

A method for controlling a melt-processing installation, wherein the installation has a melt-feed device, a filtering device, and a melt-processing device. Optionally, a melt pump can be used in addition to, or in lieu of, the melt-feed device. A maximum achievable rate of volume change per unit time of a volumetric feed of the melt-feed device and/or of the melt pump is determined, a maximum volume deviation value of the volumetric feed per unit time to the melt-processing device is determined, and a volume change in the filtering device between the melt-feed device and/or the melt pump and the melt-processing device is set such that a resulting rate of volume change of the filtering device is less than, equal to, or slightly larger than the maximum achievable rate of volume change of the melt-feed device and/or of the melt pump so that the maximum volume deviation value is not exceeded.

### CROSS REFERENCE TO RELATED APPLICATION

The present patent application is a Continuation Application that claims priority to and the benefit of co-pending International Patent Application No. PCT/EP2014/000806 filed Mar. 25, 2014, entitled “METHOD FOR CONTROLLING A MELT-PROCESSING INSTALLATION”, which claims priority to DE Application No. 102013005199.1 filed Mar. 25, 2013. These references are hereby incorporated in their entirety.

### FIELD

The present embodiments generally relate to a method for controlling a melt-processing installation.

### BACKGROUND

Melt-processing installations with a melt-feed device, a filtering device, a melt-processing device, and if applicable with a melt pump in addition thereto, are used for the processing of plastic melts. Such plastic melts can be polymer plastic melts. The melts can be processed in extrusion lines wherein an extruder or a melt pump can be used as the melt-feed device, by means of which a melt can be continuously delivered volumetrically to extrusion lines. Gear pumps can be implemented as melt pumps. A device that extrudes or molds, e.g., films, tubes, profiles, flat profiles, sheets or the like in a continuous extrusion process, can be used as the melt-processing device.

Melts to be processed can be contaminated, particularly in the processing of plastics, including. For example, when recycled plastic material is appropriately admixed, and/or especially high purity requirements are placed on the melt materials to be processed, a filtering device can be provided that filters out the corresponding contaminants ahead of the melt-processing device. Such filtering devices can typically result in a pressure drop that is sometimes nonlinear, and can cause a corresponding unwanted pressure drop on the molten mass conveyed by the melt-feed device/extruder or by the melt pump/gear pump which must be compensated for.

In embodiments, devices for filtering a fluid can be implemented as screen changers. With devices of this type, foreign particles can be filtered out of fluid, such as from molten plastic in the form of its polymer melt. Recycled material can have a greater degree of corresponding contaminants. In the course of filtering, the corresponding filter or the corresponding screen nest can clog with residues, and require cleaning.

In embodiments, two filter systems can be arranged in parallel with one another so that it is possible to allow one filter system to continue to operate while the other undergoes cleaning. In this context, cleaning can be performed by what is called backwashing with already-filtered fluid in the direction opposite to the normal direction of production flow of the fluid. Devices are known for this purpose, and are referred to by persons having ordinary skill in the art as backflow screen changers. Manual service with a screen change then only needs to take place after a certain number of automatic backwash processes, as appropriate.

When filtering devices of this type are used in applications that must carefully control the mass flow of the fluid, such as manufacturing low-thickness plastic films, it is desirable to be able to ensure a continuous flow of filtered fluid without particular variations per unit of time even when a filter must be cleaned or changed.

Devices are known to persons having ordinary skill in the art, such as those used in plastic-processing installations, which are intended to maintain a constant volumetric flow rate even in the event of backwashing.

In a typical design, an additional displacement piston is employed in a melt passage downstream of a filter nest which can force cleaned melt through the suitably positioned filter in the direction opposite to the production direction in the backwash process. In addition, a substantially continuous melt flow can be maintained, even in the event of cleaning, due to the multi-part design and the distribution of functions among the displacement pistons and various pistons that carry the actual filter.

In the case of melt materials with relatively large proportions of contaminants, such as recycled plastic materials, continuously operating backflow screen changers are used. In these devices, a self-cleaning backwash mode can cause contamination retained in the filter or the corresponding screen cavity to be removed and discharged from the filtering device by a melt flow applied in the counterflow direction. However, it may be disadvantageous here that too high a volume of material is removed from the melt flow during operation of such a backwash screen changer, which can disrupt normal production operation.

Since it is nonetheless necessary to remove material from the production process during backwashing or in the event of a screen change of filtering devices, this removal of melt volume from the flow of production leads to problems with the continuous supply of melt material to the melt-processing device.

For example, in the manufacture of flat films, it is necessary to keep the supply of melt material constant to within one percent by volume of the required production melt flow in order to be able to reliably avoid variations in a film thickness or flaws in the film material.

Methods for controlling plastics processes are known to persons having ordinary skill in the art, such as additional volume controls or volume regulation that can be activated to affect a melt-feed device such that a volume change is compensated for. In these types of designs, the melt pressure is used as the controlled variable for a constant-pressure control of the volumetric flow of the melt.

Also known to persons having ordinary skill in the art are filtering devices in which the pressure drop or volume decrease due to removal of material from the process is can be compensated for by controlling the fill level of a feed device and employing a pressure generator to achieve a constant pressure and constant volume at the discharge.

It is the object of the present invention to provide a method for controlling a melt-processing installation, in particular for processing a plastic melt that permits cleaning or replacement of filter elements of a filtering device thereof in the simplest, most reliable, and most effective manner possible without interrupting the material flow of the melt through the melt-processing device, wherein, in particular, the reliable and substantially constant melt flow to the melt-processing device is to be ensured under all operating conditions.

It is desirable to avoid the above-described disruption of a constant volumetric melt flow. The present invention allows for backwashing of melt material without disruptions and volume losses in the primary flow of melt material during backwashing. In this process, the amount of time in which volume of the melt material is altered can be kept as short as possible.

This object is attained by the present invention by applying a method for controlling a melt-processing installation.

### BRIEF DESCRIPTION OF THE DRAWINGS

The detailed description will be better understood in conjunction with the accompanying drawings as follows:

FIG. 1 is a schematic view of a melt-processing installation in which the present method for controlling such an installation can be used.

FIG. 2 is a graphic representation of the throughputs and rates of volume change according to one embodiment of the method.

FIG. 3 is a representation of rates of volume change or throughputs during operation of a melt-processing installation according to the prior art.

The present embodiments are detailed below with reference to the listed Figures.

### DETAILED DESCRIPTION OF THE EMBODIMENTS

Before explaining the present apparatus in detail, it is to be understood that the apparatus is not limited to the particular embodiments and that it can be practiced or carried out in various ways.

Specific structural and functional details disclosed herein are not to be interpreted as limiting, but merely as a basis of the claims and as a representative basis for teaching persons having ordinary skill in the art to variously employ the present invention.

The method is used to control a melt-processing installation, wherein the installation has a melt-feed device, a filtering device, and a melt-processing device. The melt processing installation can also have a melt pump., a maximum achievable rate of volume change per unit time of the volumetric feed of the melt-feed device and/or of the melt pump is determined, wherein the rate of volume change is defined as the change per unit time of the volumetric feed per unit time.

A maximum volume deviation value of the volumetric feed per unit time to the melt-processing device is then defined, and a volume change in the filtering device between the melt-feed device and/or melt pump and the melt-processing device is set such that a rate of volume change of the filtering device resulting from this volume change per unit time is less than, or equal to, or only slightly larger than the maximum achievable rate of volume change of the melt-feed device and/or of the melt pump so that the maximum volume deviation value at the melt-processing device is not exceeded in the positive or negative direction.

A completely new and different methodology is followed as compared to the known prior art. Primary dependence is not placed on constant pressure in the method sequence. Instead, the throughputs of the melt from the melt-feed device through the filtering device to the melt-processing device are concretely employed as relevant parameters for reliable operation of the device within the meaning of the method.

Thus, the rate of volume change per unit time of the volumetric feed of the melt-feed device and/or of the melt pump provides a measure of how the melt throughput (volume per unit time) over time can be increased or decreased through appropriate control of the melt-feed device and/or of the melt pump.

In other words, this characteristic quantity of the maximum achievable rate of volume change of the volumetric feed per unit time is a measure of how much additional or reduced melt volume per unit time can be delivered in a specific amount of time.

The appropriate delivery rate is therefore matched on the melt feed side. An additional criterion here is that the maximum volume deviation value of the melt that is delivered to the melt-processing device as volume per unit time (throughput) must lie within the range of the maximum permissible volume deviation there. In other words, the throughput (volume per unit time) of melt that is fed to the melt-processing device must only be variable within the limits of the maximum volume deviation value. In this way it can be ensured that the manufacturing process in the melt-processing device can proceed continuously and in a constant manner even in the presence of volume variations ahead or upstream of the melt-processing device.

In the case of additional volume needing to be removed proximate the filtering device, such as during a backwash process or servicing work, melt is also diverted there from the melt throughput that is fed from the melt-feed device and/or from the melt pump and is not conveyed onward to the melt-processing device.

In this process, it is necessary to maintain the criterion that the volume change in the filtering device between the melt-feed device and/or the melt pump and the melt-processing device is set such that the result is a rate of volume change of the filtering device resulting from this volume change per unit time that is preferably less than, or equal to, or only slightly larger than the maximum achievable rate of volume change of the melt-feed device and/or of the melt pump.

This means that the volume per unit time removed from the production flow in the region of the filtering device is permitted to change over time only at such a rate that the resulting throughput change in the region of the filtering device can be compensated for by the corresponding throughput change over time in the region of the melt-feed device and/or of the melt pump such that no throughput change subsequently occurs in the region of the melt-processing device that negatively affects the production process. In this manner, the throughput change is always within the maximum volume deviation value as defined.

In embodiments, the specification or determination of the maximum achievable rate of volume change of the volumetric feed per unit time of the melt-feed device and/or of the melt pump can either be determined ahead of time and then specified as known, or can be determined during the production process through appropriate sensors.

The permissible rate of volume change of the filtering device can also be determined according to the predefined maximum achievable rate of volume change and adapted thereto.

Even essential values, such as the maximum volume deviation value, which is the maximum permissible throughput variation to the melt-processing device, can either be specified ahead of time during the design of a melt-processing installation or can be determined by appropriate sensors during operation of the installation and sensed as the control quantity/controlled variable.

A value of a production parameter can be ascertained by means of a measurement device, wherein the value of the production parameter is delivered to a device for adjusting the volumetric feed from the melt-feed device and/or melt pump and/or for setting the volume change in the filtering device, so that the maximum volume deviation value is not exceeded.

Consequently, the device for adjusting the volumetric feed, which can ascertain the setting of the appropriate throughput quantity as a function of the determination of a production parameter by means of a suitable measurement device, can be used for controlling the method.

For example, such a measurement device can involve the measurement of the production parameter of the thickness d of a correspondingly extruded film in the case that the melt-processing device is an extrusion device for producing a plastic film web from appropriate melt material.

In embodiments, the measurement device can be a thickness measuring device by means of which a thickness d, such as a thickness of a film web produced in the melt-processing device is ascertained. The appropriate measurement of the production parameter of the pressure with which the melt is fed to the melt-processing device can also be used for the control. Persons having ordinary skill in the art will be able to ascertain an applicable production parameter to measure and correspondingly control the method.

The device for adjusting the volumetric feed from the melt-feed device and/or of the melt pump and/or for setting the volume change in the filtering device can be a closed-loop control system that uses at least the value of the production parameter as the basis for closed-loop control, so that the maximum volume deviation value is not exceeded.

Such closed-loop control allows on-line control of relevant method steps so that the product produced by the method can always be manufactured within desired manufacturing tolerances. To this end, the value of the production parameter, for example the thickness d of a plastic film web to be produced, can be employed as the basis for the control. As soon as deviations arise in the area of the thickness measurement, a closed-loop adjustment of the production parameter, such as the throughput of the melt flow, can then be undertaken according to the above-described method steps.

According to another embodiment of the method, the device for adjusting the volumetric feed from the melt-feed device and/or of the melt pump and/or for setting the volume change in the filtering device is an open-loop control system. The adjustment of the volumetric feed from the melt-feed device and/or of the melt pump can take place as part of open-loop control, in which at least the value of the production parameter is used so that the maximum volume deviation value is not exceeded. Such an open-loop control system is relatively simple to implement and is based on the predetermined installation parameters that are defined during design of the installation.

In embodiments, the value of the volume change in the filtering device between the melt-feed device and/or melt pump and melt-processing device can be adjusted continuously.

In embodiments, the value of the volume change in the filtering device between the melt-feed device and/or melt pump and melt-processing device can also be adjusted in a stepwise fashion.

In embodiments, a maximum value of the volumetric feed per unit time of the melt-feed device and/or of the melt pump can be determined and the maximum achievable rate of volume change of the melt-feed device and/or of the melt pump can be present only until the maximum value of the volumetric feed is achieved. Alternatively, the maximum achievable rate of volume change of the melt-feed device and/or of the melt pump is present only until the value of the volumetric feed is brought back from the maximum value of the volumetric feed to the production target value that has been determined.

The maximum value of the volumetric feed per unit time of the melt-feed device and/or of the melt pump can specify how high the maximum possible value of the throughput of the installation can be. Accordingly, this also can result in a natural upper limit, up to which a volume removal in the region of the filtering device is possible at all. If the capability for throughput increase of the melt-feed device and/or of the melt pump is utilized to its maximum value, a further volume removal in the region of the filtering device can no longer be compensated for, so that it would no longer be possible to meet the condition of minimal volume deviation of the throughput to the melt-processing device. Hence, especially reliable operation of installations within the required production tolerances can easily be achieved by defining the appropriate maximum value before putting the installation into operation or online during system operation.

In embodiments, the maximum volume deviation value lies in a range from 0.0 to 1.0% of the volumetric feed per unit time to the melt-processing device. Especially reliable operation of many installations can be ensured with a value for the deviation of 0.0 to 1.0%.

The removed throughput can be adjusted in the region of the filtering device, wherein tracking is carried out based on the removed throughput according to the throughput that is delivered on the part of the melt-feed device and/or of the melt pump. Consequently, the ability to tune the throughput change or the maximum throughput change of the melt-feed device and/or of the melt pump and the throughput change in the region of the filtering device can be used to remove melt material in an accelerated fashion.

The removed throughput can be increased to such a degree that a faster removal of melt material from the volumetric flow of the production and tracking of additional melt material can be possible by increasing the corresponding throughput on the part of the melt-feed device and/or of the melt pump without the maximum volume deviation value in the region of the melt-feed to the melt-processing device being positively or negatively exceeded.

Consequently, continuous production operations without relatively large mass variations in the production flow of the filtered melt is possible by utilizing the method as described, wherein the appropriate backwash cleaning or service work on individual filter elements can take place at the same time.

The invention is explained in detail below strictly by way of example, without being limited to the embodiments shown. The figures show:

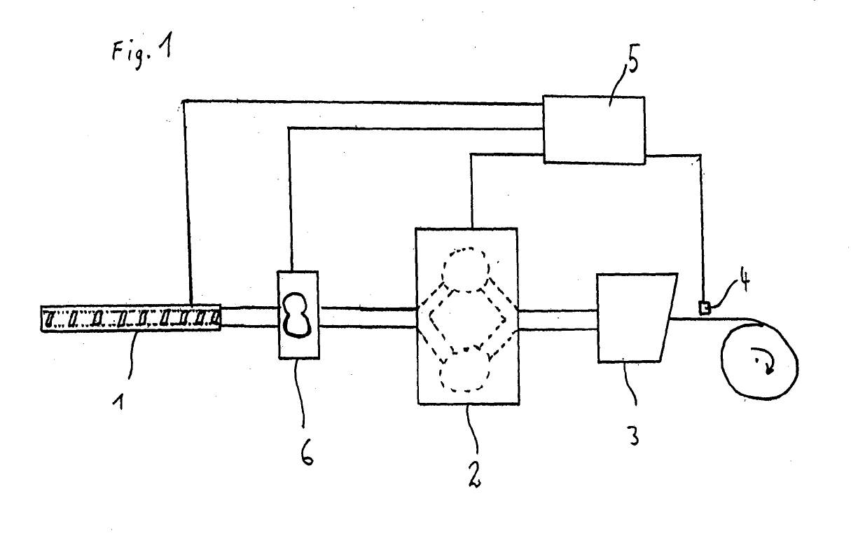

FIG. 1 shows an embodiment of a melt-processing installation in a schematic representation. The method can be carried out using this, or a similar installation. The installation has a melt-feed device 1, a filtering device 2, and a melt-processing device 3. Also shown is a melt pump 6. In embodiments, an installation can be operated without the melt pump 6 if desired.

For example, a single-screw extruder or a twin-screw extruder, can serve as the melt-feed device 1. In embodiments, a twin-screw extruder with counter-rotating twin screws can be used as the twin-screw extruder. When an extruder with counter-rotating twin screws is used, this device can provide sufficient melt material for most processes with a relatively high melt pressure. In systems such as this, the use of a melt pump 6 in particular may be unnecessary. In contrast, when a twin-screw extruder with co-rotating twin screws is used, it may be necessary to take into account that the achievable pressure levels here typically may not be at desired levels, so a melt pump 6 can additionally be used for pressure generation. The melt pump 6 can be a gear pump, for example.

For the filtering device 2, it is possible to use a known backwash screen changer, in which backwashing of the melt material can be used in two or more screen cavities for cleaning the screens there. As discussed, this requires an additional melt volume, which can be removed from the production flow of the melt through the filtering device there. The corresponding volume removal and the compensation thereof are the subject matter of the present invention.

A sheet extrusion die, for example, can be used as the melt-processing installation 3, which can produce a film web of melt material. Various embodiments of such systems produce film from plastic melt material in various widths, such as 60 to 140 cm. While a film producing installation is employed for illustrative purposes, persons having ordinary skill in the art will appreciate that various other processes utilizing melt material can be controlled by the present invention.

FIG. 1 also shows a measurement device 4, such as a thickness measuring device, which can measure a thickness d of a film web being produced by a melt-processing device 3 implemented as a sheet extrusion die. Such a thickness measuring device is actually known in principle. The film web can be rolled at the end of the melt-processing process.

Also shown in FIG. 1 is a device 5 for adjusting the volumetric feed from the melt-feed device and/or of the melt pump and/or for setting the volume change in the filtering device 2. The device 5 here can be a closed-loop control system, which can regulate the corresponding throughputs based on the thickness d of the film web, determined by the measurement device 4.

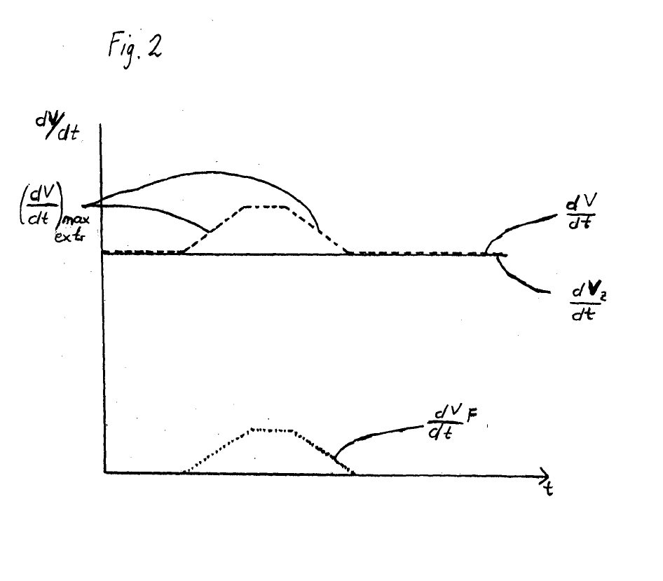

FIG. 2 shows a curve of the rates of volume change and the throughputs of a melt-processing installation according to an embodiment of the method.

A maximum achievable rate of volume change per unit time of the volumetric feed of the melt-feed device 1 and/or of the melt pump 6 is determined on-line or before putting the melt-processing installation into operation, i.e. it is determined how the throughput of the volumetric flow can change per unit time in the fastest case. This is represented by the slopes of the corresponding lines of the volume change curve in FIG. 2.

The maximum value of the volumetric feed per unit time (of the throughput) of the melt-feed device 1 and/or of the melt pump 6 is also determined in a manner that how much the volumetric throughput of the melt feed can be increased is known. As is evident from the illustration in FIG. 2, a volume change in the filtering device 2 between the melt-feed device 1 and/or of the melt pump 6 and the melt-processing device 3 is set such that the rate of volume change in the filtering device 2 resulting from this volume change per unit time can be smaller than, equal to, or slightly greater than the maximum achievable rate of volume change of the melt-feed device 1 and/or of the melt pump 6.

In the example shown, the volume change in the melt device 2 corresponds to the maximum fastest achievable rate of volume change of the melt-feed device 1 and/or of the melt pump 6. In this case, the two melt volume changes compensate for one another such that the maximum volume deviation value of the volumetric feed per unit time to the melt-processing device 3 is not positively or negatively exceeded.

This maximum volume deviation value is not shown in FIG. 2, but it follows from the illustration in FIG. 2 that the curve of the volumetric feed per unit time to the melt-processing device 3 proceeds as a straight line with no deviations, even during the time period in which the volume in the region of the filtering device 2 is diverted from the melt flow to the melt-processing device 3 (area under the curve of the illustration of the volume change of the filtering device 2 is equal to the area under the line of the volume change of the melt feed 1 and/or of the melt pump 6 in FIG. 2).

The method can therefore be represented in a formula as follows:

dV_{F}/dt≦(dV/dt)maxextr.

or

dVF/dt≧(dV/dt)maxextr.

where the following must also always be true: dV_{z}/dt< maximum volume deviation value, e.g. ±1.0% of the target value of the volumetric feed per unit time to the melt-processing device 3.

Here:

dV_{F}/dt=volume change in the filtering device 2.
dV/dt=volume change of the melt-feed device 1 and/or of the melt pump 6.
dV_{z}/dt=volumetric feed per unit time to the melt-processing device 3.
max extr.=maximum achievable volume change/rate of volume change of the melt-feed device 1 and/or of the melt pump 6.

The total volume of the melt removed for backwashing or filling in the region of the filtering device 2 results from the integral under the corresponding curve of the volume change value in the filtering device 2. Accordingly, the additional melt volume made available from the melt-feed device 1 and/or the melt pump 6 results as the integral between the corresponding curve of the volume change of the melt-feed device 1 and/or of the melt pump 6 and the straight line that characterizes the volumetric feed per unit time to the melt-processing device 3 (horizontal curve in FIG. 2).

As explained, FIG. 2 shows a case in which the fastest possible filling of the reservoir as defined by the method takes place while exploiting the maximum possible readjustment capability of the melt feed and removing the required volume quantity from the volumetric flow as quickly as possible.

In case that removal should take place somewhat more slowly, the shape of the curve of the volume change in the filtering device 2 could be implemented as, for example, a sawtooth that would run within the curve shape of the volume change in the filtering device 2 in FIG. 2, which is then to be viewed as an envelope curve.

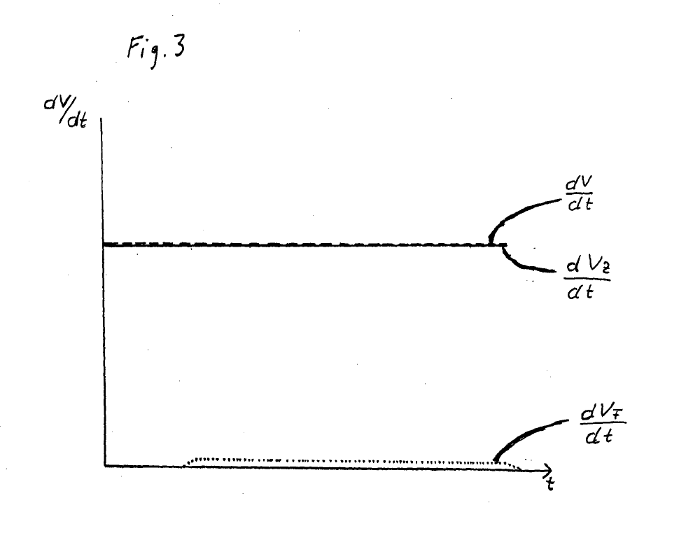

FIG. 3 shows the shape of achievable rates of volume change in a method for controlling a melt-processing installation according to the prior art.

In contrast to the illustration in FIG. 2 it is evident there that the rate of volume change, i.e. the melt throughput quantity removed from the melt production flow over time, must take place over a relatively long time in the region of the filtering device in order to ensure that the maximum volume deviation value of the volumetric feed per unit time (of the throughput) to the melt-processing device 3 is not positively or negatively exceeded. The area under the curve of the volume change per unit time in the region of the filtering device 2 here corresponds to the total volume removed, which is then available in the region of the filtering device 2 for backwashing or refilling.

In this case, this area is essentially equal to the area under the corresponding curve of the illustration in FIG. 2, wherein it is evident in direct comparison that through operation in accordance with the invention of the installation according to the method in FIG. 2, filling with a corresponding volume can take place considerably faster, which can reduce dwell time of melt in the region of the filtering device 2 and can thus make the backwash procedure especially simple and reliable, since disruptions that may arise due to cracking or solidification of melt material during the accumulation of the volume in the region of the filtering device 2 can be avoided to a great extent.

As is evident in FIG. 3, the prior art provides no readjustment of the volumetric feed per unit time from the melt-creating apparatus 1 and/or from the melt pump 6. The melt-creating apparatus 1 and the melt pump 6 operate with essentially constant rates of volume change, i.e. with constant throughput.

### EXAMPLE

In the case of a twin-screw extruder as the melt-feed device 1 and a gear pump as the melt pump 6 as well as a backwash filter device 2 and a slot nozzle arrangement as the melt-processing installation 3, the following numerical values could result by way of example.

If one proceeds from a maximum thickness deviation value that is permissible for the variation of the film thickness, such as 1% of the film thickness, then for a melt pressure in the region of 50 to 120 bar approximately one to four kg of melt are required for backwashing.

The melt-feed device 1 or the melt pump 6 can provide, for example, 500 kg mass throughput per hour in normal operation. The mass feed per unit time in this instance can be increased to a maximum of approximately 550 kg per hour.

In order to remove the required one to four kg of melt, according to the predetermined maximum achievable rate of volume change of the volumetric feed per unit time of the melt-feed device and/or of the melt pump, a maximum achievable rate of volume change of 0 to 9% of the total delivery rate over a period of 70 seconds is possible.

Consequently, this applies to both the corresponding acceleration (rising portion of the curves in FIG. 2) as well as the deceleration (falling portion of the curves in FIG. 2) of the volume change in the filtering device with a corresponding rate of change. With a corresponding maximum value of the volumetric feed per unit time of the melt-feed device and/or of the melt pump (horizontal section of the curves in FIG. 2), one thus obtains in total a provision of the stated volume within approximately 11 minutes.

In comparison, with a conventional method such as is reproduced in FIG. 3, for example, it is only possible to provide the corresponding volume within a period of approximately one hour, since no compensation of the removed volume flow takes place there through corresponding readjustment of the delivered volume quantity.

While these embodiments have been described with emphasis on the embodiments, it should be understood that within the scope of the appended claims, the embodiments might be practiced other than as specifically described herein.

What is claimed is:

1. A method for controlling a melt-processing installation, wherein the installation has a melt-feed device, a filtering device, and a melt-processing device, wherein a maximum achievable rate of volume change per unit time of the volumetric feed of the melt-feed device is determined, a maximum volume deviation value of the volumetric feed per unit time to the melt-processing device is defined, and a volume change in the filtering device between the melt-feed device and the melt-processing device is set such that a rate of volume change of the filtering device resulting from the volume change per unit time is less than, equal to, or slightly larger than the maximum achievable rate of volume change of the melt-feed device such that the maximum volume deviation value is not exceeded.

2. The method of claim 1, wherein a value of a production parameter is ascertained by means of a measurement device, wherein the value of the production parameter is delivered to a device for adjusting the volumetric feed from the melt-feed device or for setting the volume change in the filtering device so that the maximum volume deviation value is not exceeded.

3. The method of claim 2, wherein the measurement device is a thickness measuring device by means of which a thickness d of a film web produced in the melt-processing device is determined.

4. The method of claim 2, wherein the device for adjusting the volumetric feed from the melt-feed device or for setting the volume change in the filtering device is a closed-loop control system that uses at least the value of the production parameter as the basis for closed-loop control, so that the maximum volume deviation value is not exceeded.

5. The method of claim 2, wherein the device for adjusting the volumetric feed from the melt-feed device or for setting the volume change in the filtering device is an open-loop control system.

6. The method of claim 1, wherein the value of the volume change in the filtering device between the melt-feed device and the melt-processing device is adjusted continuously.

7. The method of claim 1, wherein the value of the volume change in the filtering device (2) between the melt-feed device and the melt-processing device is adjusted in a stepwise fashion.

8. The method of claim 1, wherein a maximum value of the volumetric feed per unit time of the melt-feed device is determined and the maximum achievable rate of volume change of the melt-feed device is present only until the maximum value of the volumetric feed is achieved.

9. The method of claim 1, wherein the maximum volume deviation value lies in a range from 0.0 to 1.0% of the volumetric feed per unit time to the melt-processing device.

10. A method for controlling a melt-processing installation, wherein the installation has a melt pump, a filtering device, and a melt-processing device, wherein a maximum achievable rate of volume change per unit time of the volumetric feed of the melt pump is determined, a maximum volume deviation value of the volumetric feed per unit time to the melt-processing device is defined, and a volume change in the filtering device between the melt pump and the melt-processing device is set such that a rate of volume change of the filtering device resulting from the volume change per unit time is less than, equal to, or slightly larger than the maximum achievable rate of volume change of the melt pump such that the maximum volume deviation value is not exceeded.

11. The method of claim 10, wherein a value of a production parameter is ascertained by means of a measurement device, wherein the value of the production parameter is delivered to a device for adjusting the volumetric feed from the melt pump or for setting the volume change in the filtering device so that the maximum volume deviation value is not exceeded.

12. The method of claim 11, wherein the measurement device is a thickness measuring device by means of which a thickness d of a film web produced in the melt-processing device is determined.

13. The method of claim 11, wherein the device for adjusting the volumetric feed from the melt pump or for setting the volume change in the filtering device is a closed-loop control system that uses at least the value of the production parameter as the basis for closed-loop control, so that the maximum volume deviation value is not exceeded.

14. The method of claim 11, wherein the device for adjusting the volumetric feed from the melt pump or for setting the volume change in the filtering device is an open-loop control system.

15. The method of claim 10, wherein the value of the volume change in the filtering device between the melt pump and the melt-processing device is adjusted continuously.

16. The method of claim 10, wherein the value of the volume change in the filtering device between the melt pump and the melt-processing device is adjusted in a stepwise fashion.

17. The method of claim 10, wherein a maximum value of the volumetric feed per unit time of the melt pump is determined and the maximum achievable rate of volume change of the melt pump is present only until the maximum value of the volumetric feed is achieved.

18. The method of claim 10, wherein the maximum volume deviation value lies in a range from 0.0 to 1.0% of the volumetric feed per unit time to the melt-processing device.
